(19) United States
(12) Patent Application Publication
(10) Pub. No.: US 2014/0156607 A1
(43) Pub. Date: Jun. 5, 2014

(54) INDEX FOR DEDUPLICATION

(71) Applicant: HEWLETT-PACKARD DEVELOPEMENT COMPANY, L.P., Houston, TX (US)

(72) Inventor: Mark David Lillibridge, Mountain View, CA (US)

(21) Appl. No.: 14/234,146

(22) PCT Filed: Oct. 18, 2011
(86) PCT No.: PCT/US11/56763

§ 371 Date: Jan. 21, 2014

(51) Int. Cl. G06F 17/30

(52) U.S. Cl. CPC G06F 17/30156
USPC 707/692

(57) ABSTRACT

Techniques for deduplication include an index, a receiver module, and an indexer module. The index can store information about data blocks. The receiver module can receive a data block. The indexer module can check whether information about the data block is in the index, and if information about the data block is not found in the index, then it can make a random decision about whether to store information about the data block in the index, and if the random decision is to store information about the data block in the index, then it can store information about the data block in the index.

### BACKGROUND

Data deduplication refers to techniques for elimination of redundant data. In the deduplication process, duplicate data is deleted, leaving only one copy of the data to be stored. Deduplication may be able to reduce the required storage capacity because only unique data is stored.

### BRIEF DESCRIPTION OF THE DRAWINGS

FIG. 1 is an example block diagram of a computer system with an index for deduplication.

FIG. 2 is a flow diagram of an example method of processing data blocks using an index for deduplication.

FIGS. 3A-3C are diagrams showing an example of data being processed by a computer system having an index for deduplication.

FIG. 4 is a block diagram showing a non-transitory, computer-readable medium that stores instructions for providing a method of processing data using an index for deduplication in accordance with an example.

### DETAILED DESCRIPTION

The present application discloses a deduplication technique to help reduce redundant data. In one example of the application, disclosed is a technique that can receive data blocks and check whether information about the data blocks is stored in an index. If information about a data block is not found in the index, then the technique can make a random decision about whether to store information about that data block in the index. If the random decision is to store information about that data block in the index, then the technique can store information about that data block in the index. In this manner, the decision about which data blocks should have their information stored in the index is random in nature.

The decision for each data block whose information is not found in the index can be based on a predetermined probability. For example, if the predetermined probability value is set to 25% then 1 out of 4 times a decision may be made to store information about a data block in the index and 3 out of 4 times a decision may be made to not store information about the data block in the index. This randomness in deciding whether to store information in the index may help reduce the size of the index because only a percentage of the data block will have their information stored in the index compared to a technique that stores information for all of the data blocks that it receives in the index.

As explained in further detail below, because of the random nature of making decisions about storing information about date blocks in the index, as more of the same data blocks are received, then more of the data blocks may have their information be stored in the index, and therefore more of the data blocks may be deduplicated. In other words, if the technique receives a data block and finds that information about the data block is already stored in the index, then the data block is a duplicate meaning that a copy of the data block has already been stored in a storage system. Furthermore, rather than making an additional copy of the data block in the storage system, the technique can make reference to the stored copy of the data block in storage.

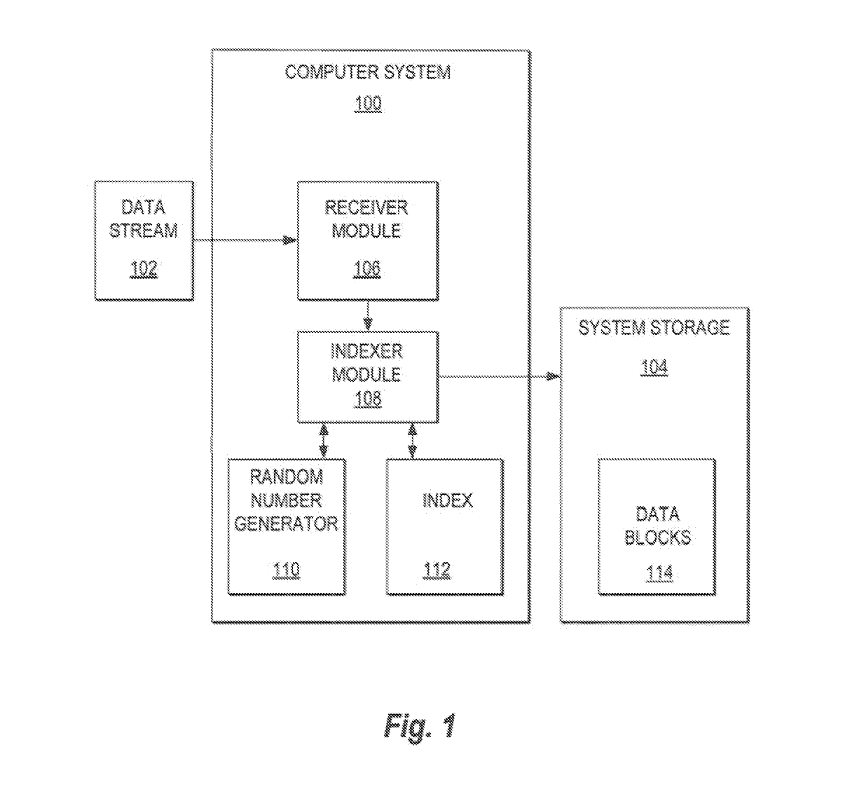

FIG. 1 is an example block diagram of a computer system 100 with an index 112 for performing deduplication. The computer system 100 includes a receiver module 106, which can receive data such as data blocks from a data stream 102. The computer system 100 can store selected data blocks of the received data as data blocks 114 in storage system 104. In addition, computer system 100 includes an indexer module 108 to make decisions about which of the received data blocks should have information about them stored in index 112. For example, indexer module 108 can check whether information about one of the received data blocks is stored in index 112. In one example, indexer module 108 can calculate a hash value based on that received data block and check whether the hash value of the data block is stored in index 112. In one example, information about the data block stored in index 112 can include a hash value of the data block. Information about the data block can also include location information about the data block such as a pointer to or a physical address of a location where the data block has been stored in storage such as storage system 104.

The indexer module 108 can determine whether information about the data block is stored in index 112. To permit this to be done efficiently, the index 112 may be indexed by the hashes of the data blocks whose information is stored in it. If indexer module 108 determine that information about the data block is not stored in index 112, then the indexer module can make a random decision about whether to store information about the data block in the index. If the random decision made by indexer module 108 is to store information about the data block in index 112, then the indexer module can store information about the data block in the index.

In one example, the indexer module 108 can make this random decision with a predetermined probability. In another example, the random decision can be based on an output of a random number generator such as random number generator 110. For example, the predetermined probability may be set to a value based on characteristics of the data received or expected to be received from data stream 102. The characteristics may include the nature of the distribution of unique date blocks from data stream 102. In one example, the random number generator may return a random number between 0 and 1, uniformly distributed. The decision may be made to store information about a data block in the index 112 if the returned number is less than the predetermined probability expressed as a fraction. In one example, if the predetermined probability is set to a value of 25% (equivalently, 0.25 expressed as a fraction), then this means that whenever the output of the random number generator is less than 0.25, a decision to store information about a data block in the index will be made. This means that about 25% of the time information about the data block will be stored in index 112 and 75% of the time information about the data block will not be stored in the index. In other words, the random decision is probabilistic and not deterministic in nature.

For example, to illustrate, suppose there are three separate users coupled to computer system 100 and that each of the users send separately identical date (perhaps a new corporate-wide memo) that is broken up into 100 data blocks. Assume further that none of these 100 data blocks has been seen by the computer system 100 before and that the random decision to store information about a data block in index 112 is made with a predetermined probability value of 25%. The first user sends the 100 data blocks to computer system 100 for processing. In this case, indexer module 108 checks index 112 for information about each of the 100 data blocks and finds no information about any of them. It then makes a random decision independently for each of the blocks on whether or not to store information about them in the index 112.

On average, it decides to store information 25% of the time, causing an average of 25% of the 100 data blocks to have their information stored in index 112. This is only an expected number, though, and in practice for any given run the actual number whose information is stored in the index 112 will vary. For this example, we will assume that 23 of the 100 blocks have information about them stored in index 112. The other 77 blocks do not have information about them stored in index 112 at this time. Note that because the blocks whose information is stored in index 112 are chosen randomly, they are very unlikely to be adjacent or concentrated in one region of the 100 blocks. Because this is the first time that computer system 100 receives the 100 date blocks, the computer system will store one copy of each of the 100 data blocks in storage system 104.

Now suppose that the second user then sends the same 100 data blocks. As explained above, of the 100 data blocks, indexer module 108 stored information for 23 of the data blocks in index 112 and did not store information for 77 of the data blocks in the index. Now when indexer module 108 checks for the 100 data blocks in the index 112, it finds information about 23 of them. Furthermore, computer system 100 will store a second copy of the 77 data blocks in storage system 104 because information about these 77 data blocks was not previously stored in index 112. In particular, although these data blocks were stored in system storage 104, the computer system 100 cannot efficiently figure this out or determine where it stored them because they are not indexed. In addition, computer system 100 does not have to store another copy of the 23 data blocks in storage 104 because information about these 23 data blocks was previously stored in index 112 by indexer module 108. That is, deduplication takes place because these 23 data blocks were found to be duplicate data blocks and therefore do not need to be stored again in storage system 104.

Now, indexer module 108 will, based on the 25% probability value, store information about on average 25% of the 77 data blocks (=0.25*77=19.25) in index 112. Let us assume in practice that information about 21 of the 77 blocks is stored in the index 112. At this point, a total of 44 data blocks (44=23+21) will have had their information stored in index 112. The number actually stored is probabilistic and if we were to repeat this example we would likely get a different number stored. The expected number of blocks stored in the index 112 at this point of the example is 100*(0.25+0.75*0.25)=43.7 blocks.

Now suppose the third user sends the same 100 data blocks as well. In this case, as explained above, information about the 23 data blocks (from the first user) and information about the 21 data blocks (from the second user) were previously stored in index 112. As explained above, indexer module 108 did not store information for 56 of the data blacks in index 112. Computer system 100 does not have to store another copy of the 44 data blocks (23 from the first user and 21 from the second user) in storage 104 because information about these 44 data blocks was previously stored in index 112 by indexer module 108. That is, deduplication takes place because these 44 data blocks were found to be duplicate data blocks and therefore do not need to be stored again in storage system 104. However, computer system 100 will store a third copy of the 56 data blocks in storage system 104 because information about these 56 data blocks was not previously stored in index 112.

Now, indexer module 108 will, based on the 25% probability value, store about 25% of the 56 data blocks (=0.25*56=14). Let us assume in practice that information about 18 of the 56 blocks is stored in the index 112. At this point, a total of 62 data blocks (62=23+21+18) will have had their information stored in index 112. The expected number of blocks stored in the index 112 at this point of the example is 100*(0.25+0.75*0.25+0.75*0.75*0.25)=57.7 blocks.

As this example helps illustrate, as more of the same data blocks are received, more of the data blocks will have their information stored in index 112 by indexer module 108, and the more duplicate data blocks that are found which do not need to be stored in storage system 104. That is, the more often the same data is received, the less the number of copies of the data blocks that need to be stored in storage system because information about the data blocks was previously stored in index 112.

As described above, indexer module 108 can store information about data blocks in index 112. In another example, indexer module 108 can also remove information about one or more data blocks previously stored in index 112 by the indexer module 108. The indexer module 108 can remove this information from index 112 based on one or more random decisions, each made with a predetermined probability. In another example, these random decisions can be based on one or more outputs of a random number generator such as random number generator 110. This can help prevent the size of the index from becoming too large and thereby help reduce excessive memory capacity requirements, for example.

As explained above, computer system 100 can store the received data stream as data blocks 114 in storage system 104. In one example, indexer module 108 can first receive data blocks from data stream 102 and decide which of the data blocks to store information about in index 112. Then, indexer module 108 can store the data blocks about which information was not found in index 112 as data blocks 114 in storage system 104. To facilitate retrieval of data blocks from storage system 104, computer system 100 can include a table of logical-to-physical address pointers. The logical address can represent a logical address of the location of one of the stored data blocks while the physical address can represent a physical address of the location of a copy of that data block stored on a physical medium of storage system 104. The table can provide a mechanism to track the location of the stored data for subsequent retrieval. For example, computer system 100 can receive from a source, such as another computer, a request to retrieve the data block at a given logical address. The request can include a logical address of the data block. In one example, indexer module 108 can use the logical address to look in the logical-to-physical address table to find the physical address corresponding to the logical address. Once the physical address is found, indexer module 108 can use the physical address to retrieve the desired data block from storage system 104 and return it to the source of the request. Although indexer module 108 is described as being able to perform the functionality of storing data blocks to storage system 104, it should be understood that another module, such as receiver module 106, can be used to perform such functionality.

The receiver module 108 is shown as being coupled to data stream 102. In one example, receiver module 106 can provide a block interface to receive data blocks from data stream 102 and to store the data as data blocks 114 on storage system 104. In another example, receiver module 106 can provide a file system interface to receive files from data stream 102 and to store the files in storage system 104, possibly in the form of date blocks 114. In another example, receiver module 106 can provide a combination of block and file system interfaces.

The computer system 100 is shown as a single computing device. However, it should be understood that computer system 100 can comprise a plurality of computing devices located centrally, distributed over wide geographical locations, or a combination thereof. The computer system 100 can be any electronic device capable of data processing. For example, computer system 100 can be a server computer, a client computer, a mobile device, and the like.

The storage system 104 is shown as a single storage element, However, it should be understood that storage system 104 can include a plurality of storage elements located centrally, distributed over wide geographical locations, or a combination thereof. The storage system 104 can be any electronic device capable of storing data for subsequent retrieval. For example, storage system 100 can be one or more disk drives, optical drives, non-volatile memory, and the like. The computer system can be part of a network such as a storage area network (SAN) local area network (LAN) network attached storage (NAS), and the like.

The data stream 102 is shown as a single source of data. However, it should be understood that data stream 102 can include a plurality of data streams located centrally, distributed over wide geographical locations, or a combination thereof. The data stream 102 is shown as a source of data from outside computer system 100. However, it should be understood that data stream 102 can include functionality to receive data from computer system 100 itself.

Although storage system 104 is shown separate from computer system 100, it should be understood that the storage system can be integrated with the computer system 100 as part of a single physical structure such as a storage chassis, for example. Although the functionality of computer system 100, such as indexer module 108, is shown as being part of the computer system, it should be understood that such functionality can be distributed among other computer systems. It should be understood that the functionality of computer system 100 can be implemented in hardware, software, or a combination thereof.

The deduplication techniques of the present application may be applicable to various computer system environments. For example, the deduplication techniques of the present application may be applicable to a virtual computer system environment. In such an environment, instead of executing software applications directly on a computer system, an intermediate software application sometimes called a hypervisor can be incorporated into the system. In this case, software applications need not execute on a real physical machine (computer) but instead can execute on a simulated computer, called a virtual machine.

The virtual computer system environment can include a server computer running several virtual machines, for example. The virtual system environment can simulate a real machine including simulated disk storage for the simulated machine. The simulated disk storage may take the form of virtual disk images, which may include the content of the simulated disk storage. Such a system may include a server running virtual machines coupled to dumb terminals which may be computing devices that simply display data and provide a keyboard for entering data. The dumb terminals may rely on having most of the computing work performed on the server in the form of virtual machines. Each of the virtual machines can have virtual disk images that may have similar content. For example, the virtual disk images may include applications such as operating systems and device drivers that may be the same on each of the virtual machines. In one example, computer system 100 may receive data from data stream 102 that may include writes or updates to virtual disk images. The virtual disk images can be in the form of data blocks that may already be divided along block boundaries. The virtual machines running on the servers may be sending data to computer system 100 as well as requesting data from computer system 100. In this case, computer system 100 can deduplicate the data blocks that make up the virtual disk images.

In another example, the deduplication techniques of the present application may be applicable to computer backup environments. In this case, computer system 100 may receive data from data stream 102 that may need to be divided along block boundaries (i.e., chunking).

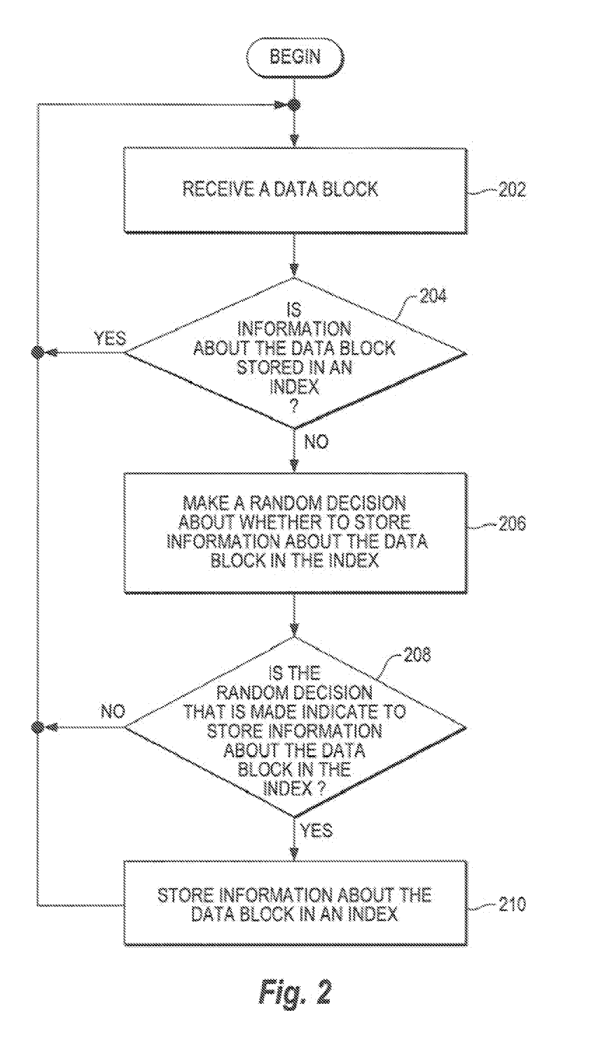

FIG. 2 shows a flow diagram of a method of processing data blocks using computer system 100 of FIG. 1, in accordance with an example of the present application. To illustrate, it will be assumed that computer system 100 can receive date blocks from data stream 102 and store information about the data blocks in index 112. It can be further assumed that computer system 100 can store data from data stream 102 as data blocks 114 in storage system 104.

At block 202, computer system 100 receives a data block for processing. For example, receiver module 106 can receive the data block from data stream 102 for subsequent processing by indexer module 108. Alternatively, receiver module 106 can divide data received from data stream 102 into one or more data blocks, including the data block in question. The indexer module 108 can determine information about the received data block. For example, indexer module 108 can calculate a hash value based on the data block. The hash value can be used by indexer module 108 for subsequent processing. For example, in block 204 below, indexer module 108 can use the hash value to determine whether the hash value of the data block is stored in index 112.

At block 204, computer system 100 checks whether information about the data block is stored in index 112. For example, as explained above, indexer module 108 can calculate a hash value based on the data block and use it to check whether the hash value of the data block is stored in index 112. If indexer module 108 determines that the hash value of the data block is stored in index 112, then this indicates that this data block is a duplicate and has bean previously stored as a data block 114 in storage system 104. In other words, the data block is a duplicate and need not be stored. In this case, processing proceeds back block 202 to allow computer system 100 to continue to receive date from data stream 102 for processing. On the other hand, if indexer module 108 determines that the hash value of the data block is not stored in index 112, then indexer module 108 can store a copy of the data block in storage 104. Furthermore, processing can then proceed to block 206 below where computer system 100 can make a decision about whether to store information about the date block in index 112.

At block 206, computer system 100 makes a random decision about whether to store information about the date block in index 112. For example, random number generator 110 can generate a uniformly distributed random number. The indexer module 108 can use the output from generator 110 to make a decision about storing information about the data block in index 112. After random number generator 110 generates an output and a decision has been made using the output from the random number generator on whether to store information about the data block in index 112, processing can proceed to block 208 below.

At block 208, computer system 100 branches based on the result of its random decision made in step 206. If it decided to store information about the data block in index 112 then processing can proceed to block 210 below where information about the data block is stored in index 112 by indexer module 108. On the other hand, if it decided not to store information about the data block in index 112 then processing can proceed back to block 202 to have computer system 100 continue to receive date from data stream 102 for processing.

At block 210, computer system 100 stores information about the data block in index 112. For example, as explained above, the information that is stored in index 112 can include the hash value of the data block. In one example, indexer module 108 can store additional information in index 112 such as a pointer to a physical address of the data block 114. This address information can be used for subsequent deduplication of incoming data blocks.

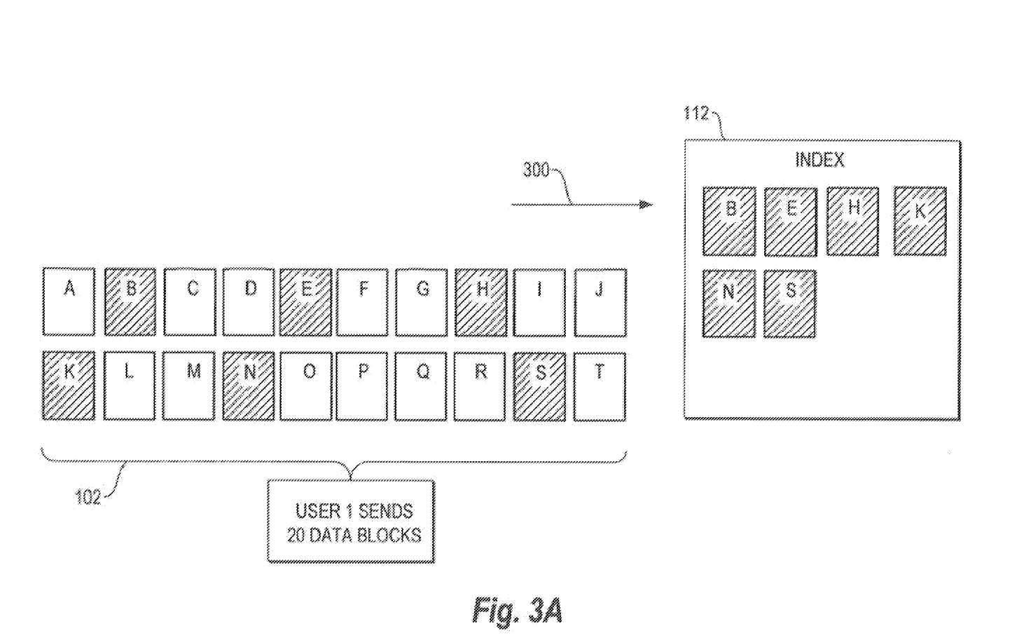

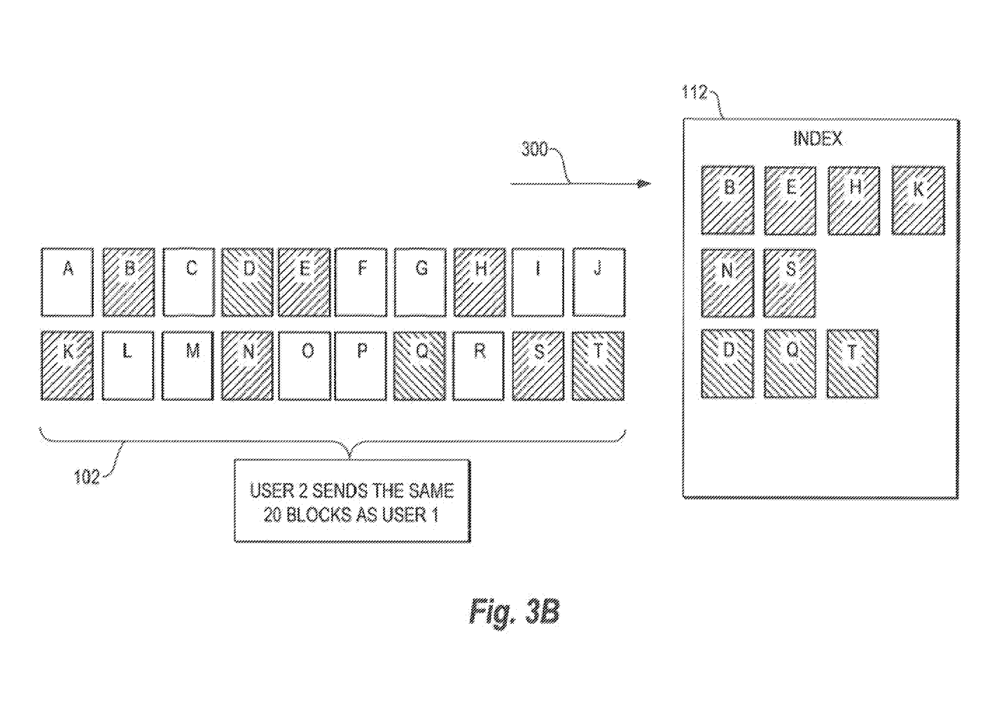

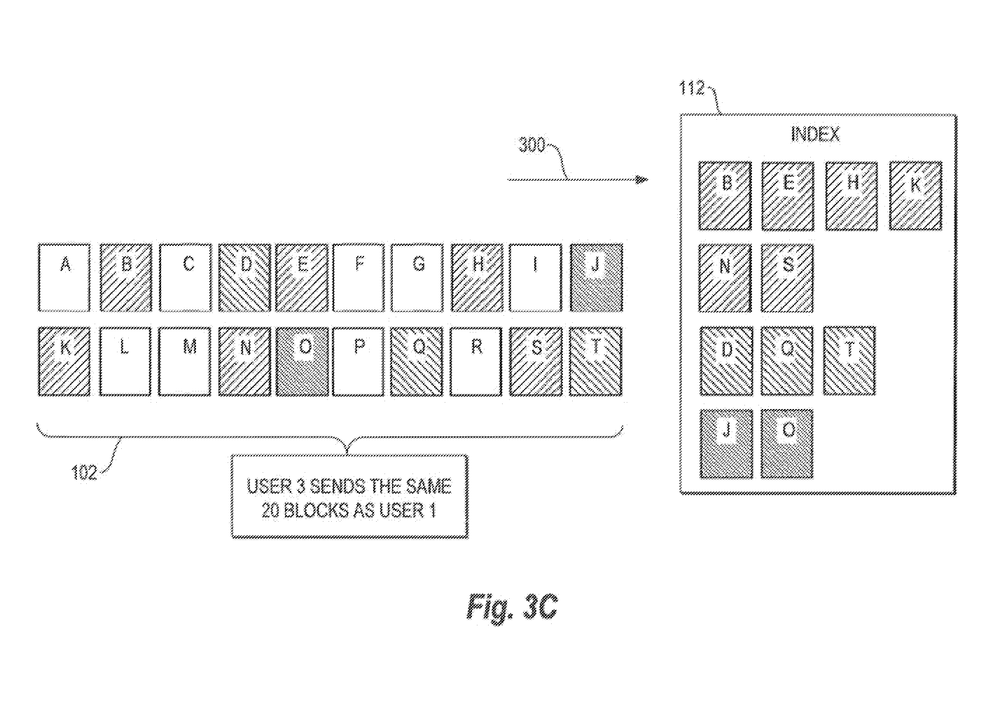

FIGS. 3A-3C are diagrams showing an example of processing data with computer system 100 having index 112 for deduplication. To illustrate, it will be assumed that computer system 100 can receive data from data stream 102 and store information about the data blocks in index 112. It can be further assumed that computer system 100 can store pieces of the data as data blocks 114 in storage system 104. In addition, in one example, it can be further assumed that data stream 102 provides 20 data blocks (Block A through Block T) and that these same data blocks are sent to computer system 100 by three different users referred to as User 1, User 2, and User 3. For example, the 20 data blocks can be part of the same electronic document, such as email content, that each of the users has received from their manager. To illustrate operation, it will be further assumed that indexer module 108 can make random decisions about whether to store the hash values of the data blocks in index 112. The indexer module 108 can make each of these random decisions with a predetermined probability such as 25%, for example. That means that, on average, 25% of the received data blocks will have their hash values stored in index 112 by indexer module 108. However, it should be understood that the above is for illustrative purposes and that a different predetermined probability value, a different number of data blocks can be used, and that a different number of users can provide the data blocks.

Referring to FIG. 3A, User 1 is the first to send the 20 data blocks (Block A through Block T) to computer system 100, The indexer module 108 can process each of the 20 data blocks (Block A through Block T) and determine whether information about the data blocks is stored in index 112. The indexer module 108 can calculate, for example, hash values baaed on the data blocks and check whether the hash values are stored in index 112. It will be further assumed, to illustrate, that this is the first time that indexer module 108 receives the 20 data blocks (Block A through Block T). In this case, index 112 will not contain a hash value of any of the 20 data blocks (Block A through Block T). Accordingly, indexer module 108 will find that the hash values of the 20 data blocks are not stored in index 112.

The indexer module 108 can then make random decisions about which of the data blocks should have their information stored in index 112 (20 decisions in all, one for each block). If the random decision made by indexer module 108 for a given data block is to store a hash value of that data block in index 112, then it can store the hash value of that data block in the index. The indexer module 108 can make these random decisions with a predetermined probability such as 25%, for example. As explained above, this means that, on average, 25% of the received data blocks will have their hash values stored in index 112 by indexer module 108. As shown in FIG. 3A, indexer module 108 determined in this case that 6 of the data blocks (Block B, Block E, Block H, Block K, Block N, and Block S) will have their hash values stored in index 112 as shown by arrow 300. It should be understood that because of the random decision making nature of the process, in a different iteration, a different number and/or set of data blocks may be selected by indexer module 108. Furthermore, because this is the first time that the 20 data blocks were received by computer system 100, the computer system will store a copy of the 20 data blocks in storage system 104.

Turning to FIG. 3B, after User 1 sent the 20 data blocks (Block A through Block T), User 2 then sends 20 data blocks to computer system 100. The data blocks from User 2 are the same data blocks as sent by User 1 in FIG. 3A above. The indexer module 108 can perform the same process as explained above in connection with FIG. 3A. For example, indexer module 108 can determine whether hash values of the 20 data blocks from User 2 are stored in index 112. In this example, this is the second time that indexer module 108 has received the 20 data blocks (Block A through Block T). Because of the random decision outcomes previously, indexer module 108 will find that the hash values of six of the blocks (Block B, Block E, Block H, Block K, Block N, and Block S) were previously stored in index 112 by the indexer module. Continuing with the example above, 14 random decisions, each with a predetermined probability of 25%, will now be made by indexer module 108 about which of the hash values of the remaining 14 data blocks (i.e., 14=20−6) to store in index 112. In this case, on average, 25% of the 14 data blocks will have their hash values stored in index 112 by indexer module 108. In one example, this may mean that indexer module 108 will store (as shown by arrow 300) the hash value of three data blocks (Block D, Block Q and Block T) in index 112. Again, it should be understood that because of the random decision making nature of the process, in a different iteration, a different number and/or set of data blocks may be selected by indexer module 108. Furthermore, computer system 100 will store a second copy of the 14 date blocks in storage system 104 because information about these 14 data blocks was not previously stored in index 112. In addition, computer system 100 does not have to store another copy of the 6 data blocks in storage 104 because information about these 6 data blocks was previously stored in index 112 by indexer module 108. That is, deduplication takes place because these 6 data blocks were found to be duplicate data blocks and therefore do not need to be stored again in storage system 104.

At FIG. 3C, User 3 then sends 20 data blocks (Block A through Block T) to computer system 100. The date blocks from User 3 are the same data blocks as sent by User 1 in FIG. 3A and by User 2 in FIG. 3B above. The indexer module 108 can perform the same process as explained above in connection with FIG. 3A and FIG. 3B above. For example, indexer module 108 can determine which hash values of the 20 data blocks from User 3 are stored in index 112. It will be assumed, to illustrate, that this is the third time that indexer module 108 has received the 20 data blocks (Block A through Block T). In this case, indexer module 108 will find that hash values of six of the blocks from the first time (Block B, Block E, Block H, Block K, Block N, and Block S) and of three of the data blocks from the second time (Block D, Block Q, and Block T) were already stored in index 112 by indexer module 108. Continuing with the example above, 11 random decisions, each with a predetermined probability of 25%, will be made by indexer models 108 about which hash values of the remaining 11 data blocks (i.e., 11=20−6−3) to store in index 112. In this case, on average, 25% of the 11 data blocks will have their hash values stored in index by indexer module 108. In one example, this means that indexer module 108 will store (as shown by arrow 300) the hash values of two data blocks (Block J and Block O) in index 112. Again, if should be understood that because of the random decision making nature of the process, in a different iteration, a different number and/or set of data blocks may be selected by indexer module 108. Furthermore, computer system 100 will store a third copy of the 11 data blocks in storage system 104 because information about these 11 data blocks was not previously stored in index 112. In addition, computer system 100 does not have to store another copy of the 9 data blocks in storage 104 because information about these 9 data blocks was previously stored in index 112 by indexer module 108. That is, deduplication takes place because these 9 data blocks were found to be duplicate data blocks and therefore do not need to be stored again in storage system 104.

As may be shown in the example above in the context of FIGS. 3A through 3C, the more times the same data blocks are received, the more of the data blocks will have their information stored in index 112 by indexer module 108, and the more duplicates that are found which do not need to be stored in storage system 104. That is, the more often the same data is received, the less the number of copies of the data blocks that need to be stored in the storage system because information about the data blocks was previously stored in index 112.

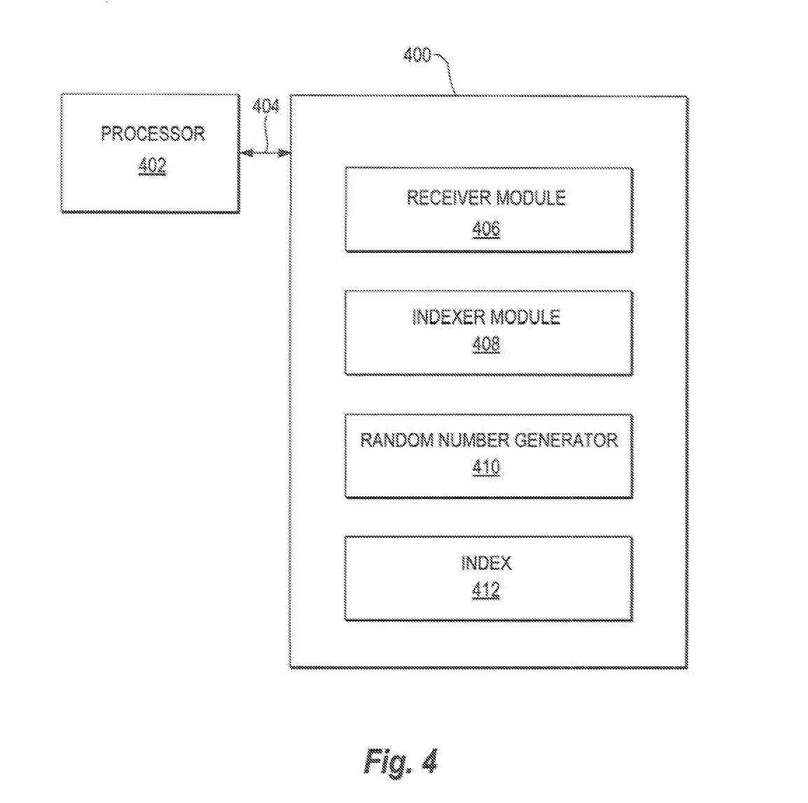

FIG. 4 is a block diagram showing a non-transitory, computer-readable medium that stores code for processing data using an index for deduplication in accordance with embodiments. The non-transitory, computer-readable medium is generally referred to by the reference number 400 and may be included in computer system 100 in relation to FIG. 1. The non-transitory computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate computer system 100 in accordance with embodiments. In an embodiment, the tangible, machine-readable medium 400 can be accessed by processor 402 over a bus 404. A region 406 of the non-transitory, computer-readable medium 400 may include receiver module 146 functionality as described herein. Another region 408 of non-transitory, computer-readable medium 400 may include indexer module 108 functionality as described herein. Another region 410 of non-transitory, computer-readable medium 400 may include random number generator 110 functionality as described herein. Region 412 of non-transitory, computer-readable medium 400 may include index 112 functionality as described herein.

Although shown as contiguous blocks, the software components can be stored in any order or configuration. For example, if the non-transitory, computer-readable medium 400 is a hard drive, the software components can be stored in non-contiguous, or even overlapping, sectors.

In the foregoing description, numerous details are set forth to provide an understanding of the present example invention. However, it will be understood by those skilled in the art that the present example invention may be practiced without these details. While the example invention has been disclosed with respect to a limited number of embodiments, those skilled in the art will appreciate numerous modifications and variations there from. It is intended that the appended claims cover such modifications and variations as fall within the true spirit and scope of the example invention.

1. A computer system for deduplication comprising:
an index to store information about date blocks;
a receiver module to receive a data block; and
an indexer module to:
check whether information about the data block is in the index, and
if information about the data block is not found in the index, then make a random decision about whether to store information about the data block in the index, and if the random decision is to store information about the data block in the index, then store information about the data block in the index.

2. The computer system of claim 1, wherein the random decision about whether to store information about the data block in the index is made with a predetermined probability.

3. The computer system of claim 1, wherein the random decision about whether to store information about the data block in the index is based on an output of a random number generator.

4. The computer system of claim 1, wherein the indexer module is further configured to calculate a hash value based on the data block and check whether the hash value is in the index.

5. The computer system of claim 1 wherein the information about the data block stored in the index comprises a hash value of the data block and a pointer to a physical address of the data block in storage.

6. The computer system of claim 1, wherein the indexer module is configured to remove the stored information about a date block in the index based on a random decision made with a predetermined probability.

7. A method of deduplication comprising:
receiving a data block;
checking whether information about the data block is in an index; and
if information about the data block is not found in the index, than making a random decision about whether to store information about the data block in the index; and if the random decision is to store information about the data block in the index, then storing information about the data block in the index.

8. The method of claim 7, wherein the random decision about whether to store information about the data block in the index is made with a predetermined probability.

9. The method of claim 7, wherein the random decision about whether to store information about the data block in the index is based on an output of a random number generator.

10. The method of claim 7, further comprising calculating a hash value based on the data block and checking whether the hash value is in the index.

11. The method of claim 7, wherein the information about the data block stored in the index comprises a hash value of the data block and a pointer to a physical address of the data block in storage.

12. The method of claim 7, further comprising removing the stored information about a data block in the index based on a random decision made with a predetermined probability.

13. A computer readable medium comprising code for deduplication that if executed causes a processor to:
receive a data block;
check whether information about the data block is in an index; and
if information about the data block is not found in the index, make a random decision about whether to store information about the data block in the index, and if the random decision is to store information about the data block in the index, store information about the data block in the index.

14. The computer readable medium of claim 13 further comprising code that if executed causes a processor to:
make the random decision about whether to store information about the data block in the index with a predetermined probability.

15. The computer readable medium of claim 13 further comprising code that if executed causes a processor to:
remove the stored information about a data block in the index based on a random decision made with a predetermined probability.
